(19) United States
(12) Patent Application Publication
(10) Pub. No.: US 2008/0128968 A1
(43) Pub. Date: Jun. 5, 2008

(54) Composite spring with bushing attachment

(76) Inventors: David K. Platner, Shelby, MI (US); Arnett R. Weber, Burlington (CA); Rajesh J. Somnay, Troy, MI (US); Holly Ann Giangrande, Troy, MI (US); Tomaz Dopico Varela, Shelby Township, MI (US); Brian J. Knouff, Massillon, OH (US); Benjamin R. Reineck, Waterford, MI (US); Norman D. Austin, Kutztown, PA (US); John E. Mutzner, Covington, OH (US)

Correspondence Address: CARLSON, GASKEY & OLDS, P.C., 400 WEST MAPLE ROAD, SUITE 350, BIRMINGHAM, MI, 48009, US

(21) Appl. No.: 11/606,796

(22) Filed: Nov. 30, 2006

(51) Int. Cl. F16F 1/18; B60G 11/10

(52) U.S. Cl. 267/260; 267/158

(57) ABSTRACT

A leaf spring for a vehicle suspension is formed from a composite material and includes at least one spring end with a curved recess. A bushing assembly is attached to the curved recess. The bushing assembly includes a mounting component and a bushing that is attached to the mounting component such that the leaf spring can be pivotally attached to a vehicle frame. The mounting component is formed around an outer periphery of the curved recess to secure the mounting component to the leaf spring such that the bushing is received within the curved recess.

### TECHNICAL FIELD

The subject invention relates to a composite spring for a vehicle suspension.

### BACKGROUND OF THE INVENTION

Vehicle suspensions include springs that cooperate with other suspension components to improve ride and handling characteristics for a vehicle. One type of spring used in vehicle suspensions is a composite leaf spring. The composite leaf spring extends in a longitudinal direction and has first and second ends that are pivotally mounted to a vehicle frame. A center portion of the composite leaf spring is supported by an axle component, which extends in a lateral direction across a width of the vehicle.

Each of the first and second ends of the composite leaf spring includes a metal bracket. Traditionally, each metal bracket comprises an aluminum extrusion that is mechanically fastened to the composite leaf spring. The metal bracket is configured to receive a press-fit bushing such that each of the first and second ends can be pivotally attached to the vehicle frame. Utilizing this type of bracket and mounting configuration is not ideal from a cost and material standpoint.

Thus, there is a need for an improved mounting interface for composite leaf springs that overcomes the deficiencies in the prior art discussed above.

### SUMMARY OF THE INVENTION

A composite spring for a vehicle suspension includes at least one end with a curved recess. A bushing assembly is attached to the composite spring within the curved recess such that the composite spring can be pivotally mounted to a vehicle frame.

In one disclosed embodiment, the bushing assembly includes a mounting component and a bushing that is attached to the mounting component. The mounting component is formed around an outer periphery of the curved recess to secure the mounting component to the composite spring such that the bushing is received within the curved recess.

In one disclosed embodiment, the mounting component includes a first portion formed around the outer periphery of the curved recess and a second portion that receives the bushing.

In one disclosed embodiment, the mounting component comprises a spool that has a reduced diameter center portion with a bore that receives the bushing. The spool has enlarged end portions that are formed around the outer periphery of the curved recess to secure the spool to the composite spring.

By shaping the composite spring to have a curved recess, it is easier to mount bushings to the composite spring, and material costs for attachment hardware are reduced. These and other features of the present invention can be best understood from the following specification and drawings, the following of which is a brief description.

### BRIEF DESCRIPTION OF THE DRAWINGS

FIG. 1 is a side view of a composite spring designed according to the prior art.

FIG. 2A is side view of a composite spring incorporating the subject invention.

FIG. 2B is top view of one example of a composite spring and bushing assembly incorporating the subject invention.

FIG. 3 is a side view of another example of a composite spring and bushing assembly incorporating the subject invention.

FIG. 4 is top view of FIG. 3.

FIG. 5A is a perspective view of one example of a mounting component for a bushing assembly used with the composite spring of FIG. 2A.

FIG. 5B is perspective view of the mounting component of FIG. 5A mounted to a composite spring.

FIG. 6 is a perspective view of another example of a composite spring and mounting component incorporating the subject invention.

### DETAILED DESCRIPTION OF THE PREFERRED EMBODIMENT

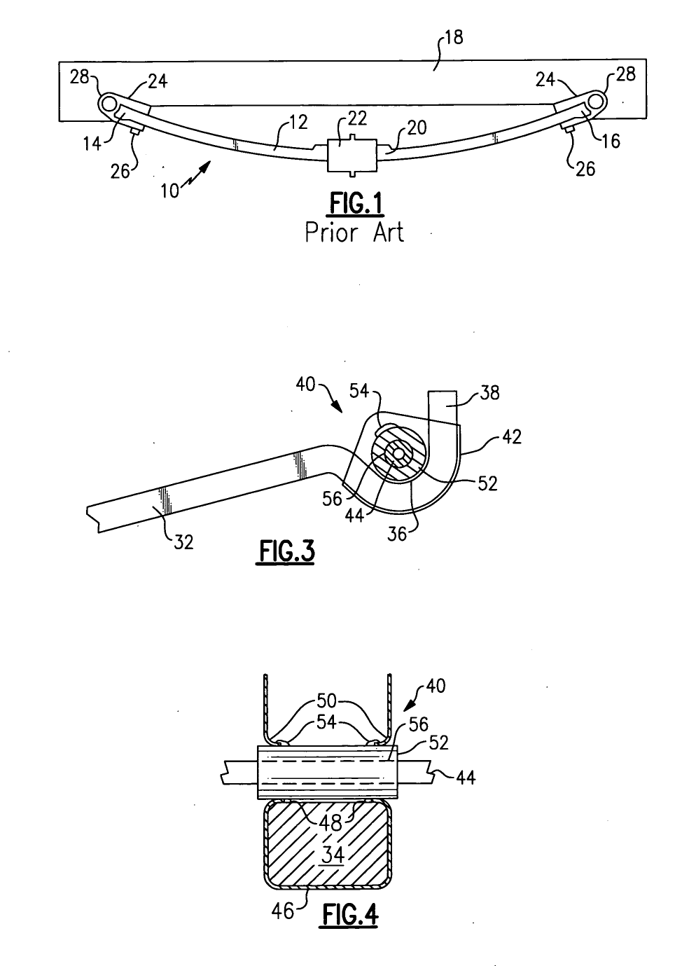

A leaf spring assembly 10 designed according to the prior art is shown in FIG. 1. The leaf spring assembly 10 includes an elongate spring body 12 formed from a composite material that includes first 14 and second 16 ends that are mountable to a vehicle structure 18, such as a frame member for example. A center portion 20 of the spring body 12 is mounted to an axle (not shown) with a mounting component 22, such as a plate and fastener assembly.

Each of the first 14 and second 16 ends includes an extruded aluminum component 24 that is mechanically attached to the spring body 12 with fasteners 26. Each extruded aluminum component 24 includes a circular boss portion 28 with a bore that receives a bushing to pivotally mount the first 14 and second 16 ends to the vehicle structure 18. The use of the extruded aluminum component 24 is disadvantageous from a cost and material standpoint.

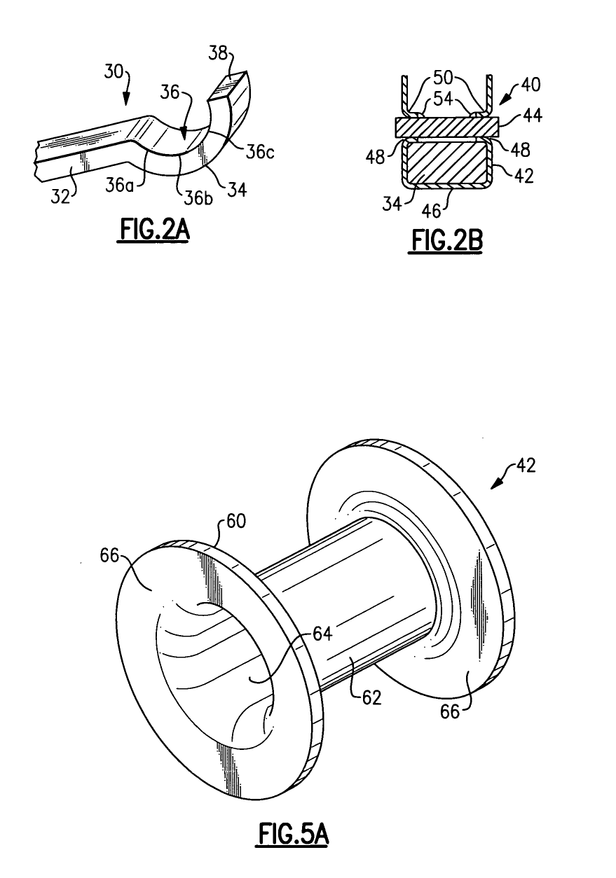

A leaf spring assembly 30 designed according to the present invention is shown in FIG. 2A. The leaf spring assembly 30 includes an elongate spring body 32 formed from a composite material that extends between first and second spring ends similar to the configuration shown in FIG. 1, however the first and second spring ends are uniquely shaped to better facilitate mounting of a bushing assembly.

FIG. 2A shows only one spring end 34, however, it should be understood that the opposite end would be similarly configured. The spring end 34 is formed to have a curved recess 36. The spring body 32 extends generally in a longitudinal direction with the curved recess 36 being integrally formed within the spring body 32 to have a first portion 36a that extends in a downward, generally vertical direction, and which transitions into a second portion 36b that extends in the longitudinal direction, and then transitions into a third portion 36c that extends upwardly to a distal tip 38. The distal tip 38 is orientated transversely to the spring body 32. Thus, the curved recess 36 is formed to generally have a C-shape when viewed from the side.

A bushing assembly 40, shown in FIG. 2B, is received within the curved recess 36. The bushing assembly 40 is used to pivotally attach the spring body 32 to the vehicle structure 18. The bushing assembly 40 includes a mounting component 42 and a bushing 44. The mounting component 42 is formed about an outer peripheral surface 46 of the curved recess 36 such that the mounting component 42 is fixed to the spring body 32. In the example shown, the mounting component 42 is bent, pressed, swaged or plastically deformed about the outer peripheral surface 46.

In the example shown in FIG. 2B, the mounting component 42 comprises a stamped metal piece with a first portion 48 that is secured to the spring body 32 and a second portion 50 that is secured to the bushing 44. The first portion 48 is formed around the outer peripheral surface and the second portion 50 is welded or mechanically retained directly to the bushing 44 as indicated at 54. This configuration is non-serviceable.

In the example shown in FIGS. 3-4, a thin-walled metal tube 52 is welded directly to the second portion 50 as indicated at 54. The first portion 48 is formed about the outer peripheral surface 46 of the curved recess 36 in a manner similar to that shown in FIG. 2B. The metal tube 52 includes a bore 56 and the bushing 44 is press-fit into the bore 56. This configuration requires an additional component, i.e. the tube 52, however, has the benefit of being serviceable.

The example of FIG. 6 is similar to that of FIG. 3. In this example, a tube 70 is mechanically retained or welded to the second portion 50. The tube 70 includes a bore 72 and the bushing 44 is press-fit into the bore 72. An end piece 74 is received within slots 76 formed in the second portion 50 to partially enclose the spring end and tube 70. The end piece 74 includes a first portion that is fixed within the slots 76 and a second portion that extends over the tube 70. This configuration is also serviceable.

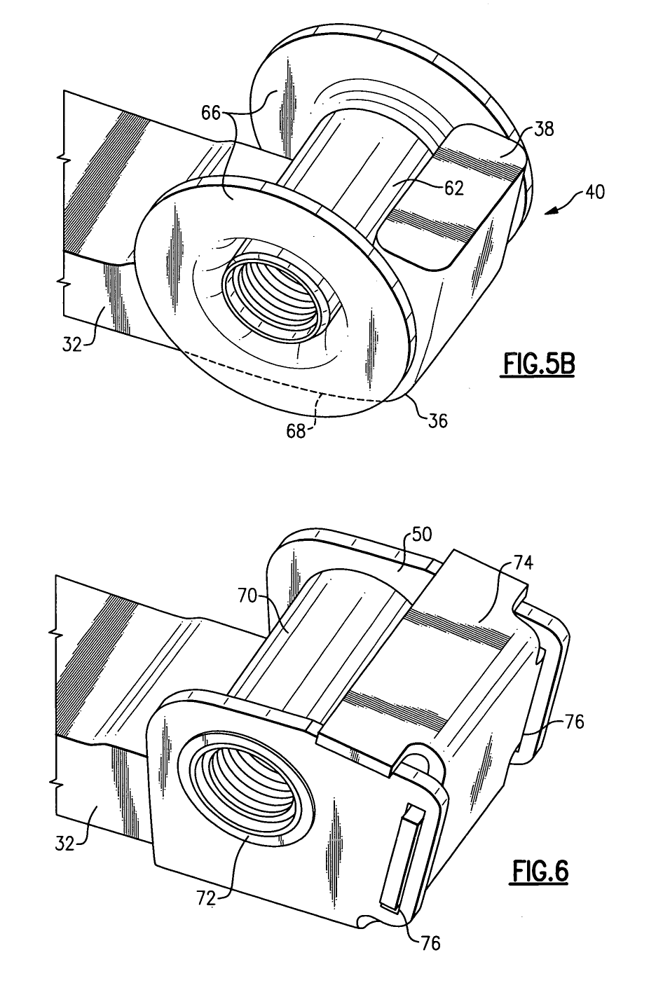

In the example shown in FIGS. 5A-5B, the mounting component 42 comprises a spool 60. The spool 60 has a reduced diameter center portion 62 that includes a bore 64. Although not shown, the bushing 44 is press-fit into the bore 64, and thus is serviceable. The spool 60 has increased diameter end portions 66 that serve to attach the spool 60 to the spring body 32. The spool 60 could be formed from a thin metal tube with the end portions 66 being formed by swaging, for example. As indicated in FIG. 5B, a bottom section 68 (indicated by dashed lines) of the end portions 66 is formed around the outer peripheral surface 46 to secure the spool 60 to the spring body 32.

Forming the spring body 32 with the curved recess 36, which is used in each of the disclosed embodiments, facilitates mounting of the bushing assembly 40 to the spring body 32. The unique configuration also is more cost effective than prior designs.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A suspension spring assembly comprising:
an elongated composite spring body having a first end and a second end longitudinally spaced apart from each other, wherein at least one of said first and said second ends comprises a curved recess; and
a bushing assembly supported within said curved recess, said bushing assembly adapted to pivotally attach said elongated composite spring body to a vehicle frame.

2. The suspension spring assembly according to claim 1 wherein said curved recess comprises a C-shape.

3. The suspension spring assembly according to claim 1 wherein said elongated composite spring body extends generally in a longitudinal direction with said curved recess first extending downwardly a generally vertical direction, then extending along the longitudinal direction, and then extending upwardly in the generally vertical direction to form a curved pocket that receives said bushing assembly.

4. The suspension spring assembly according to claim 1 wherein said bushing assembly includes a bushing and a mounting component that receives said bushing, said mounting component including a deformed portion that is formed at least partially around the elongated composite spring body at said curved recess.

5. The suspension spring assembly according to claim 4 wherein said mounting component comprises a stamped metal component having a first portion deformed around an outer periphery of said elongated composite spring body to attach said stamped metal component to said to said elongated composite spring body, and a second portion that receives said bushing assembly.

6. The suspension spring assembly according to claim 5 wherein said second portion is mechanically joined directly to said bushing.

7. The suspension spring assembly according to claim 5 including a tube positioned within said curved recess, said tube being welded to said second portion, and wherein said bushing is press-fit into said tube.

8. The suspension spring assembly according to claim 4 wherein said mounting component comprises a spool having a reduced diameter center body portion received within said curved recess of said elongated composite spring body and increased diameter end portions that are deformed around an outer periphery of said elongated composite spring body to secure said spool to said elongated composite spring body.

9. The suspension spring assembly according to claim 8 wherein said reduced diameter center body portion includes a bore that receives said bushing.

10. A vehicle suspension comprising:
at least one leaf spring formed from a composite material, said at least one leaf spring having first and second ends longitudinally spaced apart from each other, and wherein at least one of said first and second ends comprises a curved recess;
a mounting component having a deformed portion that is formed at least partially around an outer peripheral surface of said curved recess to secure said mounting component to said at least one leaf spring; and
a bushing supported by said mounting component.

11. The vehicle suspension according to claim 10 wherein said mounting component comprises a formed metal piece having a first portion deformed around said outer peripheral surface of said curved recess and a second portion that receives said bushing.

12. The vehicle suspension according to claim 11 including a tube welded to said second portion wherein said bushing is press-fit within said tube.

13. The vehicle suspension according to claim 10 wherein said mounting component comprises a spool having a reduced diameter center body portion received within said curved recess and increased diameter end portions that are deformed around opposite edges of said outer peripheral surface of said curved recess, and wherein said reduced diameter center body portion includes a bore that receives said bushing.

14. The vehicle suspension according to claim 10 wherein said curved recess comprises a C-shape.

15. A method of forming a leaf spring for a vehicle suspension comprising the steps of:
(a) forming an elongated spring body from a composite material;
(b) shaping at least one end of the elongated spring body to have a curved recess; and
(c) attaching a bushing within the curved recess.

16. The method according to claim 15 wherein step (b) includes shaping the curved recess to have a C-shape.

17. The method according to claim 15 wherein step (c) includes deforming a mounting component at least partially around an outer peripheral surface of the curved recess to secure the mounting component to the elongated spring body, and installing the bushing in the mounting component.
